(19) United States
(12) Patent Application Publication
(10) Pub. No.: US 2021/0300559 A1
(43) Pub. Date: Sep. 30, 2021

(54) MECHANICAL FUSE

(71) Applicant: Aeroster International, Inc., Sioux Falls, SD (US)

(72) Inventors: David Solum, Sunnyvale, CA (US); John Cromie, Menlo Park, CA (US)

(21) Appl. No.: 16/836,461

(22) Filed: Mar. 31, 2020

(51) Int. Cl. B64D 9/00; F16B 31/02; F16B 39/02

(52) U.S. Cl. CPC B64D 9/00; F16B 39/028; F16B 31/021

(57) ABSTRACT

Aspects of the disclosure relate to a mechanical fuse having a first component having an opening in a lower wall and a ledge arranged around the opening and a second component having a top surface with a threaded opening arranged therein. The top surface of the second component may be oriented towards the first component such that the top surface is arranged entirely below the lower wall in order to enable the first component and the second component to pivot relative to one another at the bolt. The mechanical fuse may also include a bolt having a neck including a reduced cross-sectional area portion, and the bolt is configured to break and separate the first component from the second component when a predetermined amount of force is transmitted from the first component to the reduced cross-sectional area portion via the pivoting.

### BACKGROUND

Computing devices such as personal computers, laptop computers, tablet computers, cellular phones, and countless types of Internet-capable devices are increasingly prevalent in numerous aspects of modern life. As such, the demand for data connectivity via the Internet, cellular data networks, and other such networks, is growing. However, there are many areas of the world where data connectivity is still unavailable, or if available, is unreliable and/or costly. Accordingly, additional network infrastructure is desirable.

Some systems may provide such additional network access via high-altitude platforms such as balloons and other aerial vehicles operating in the stratosphere. Such aerial vehicles may be subject to significant tensile forces during launch as well as vibration and turbulence when in flight. In addition to vibration and turbulence, the payload can experience extreme forces if or when the envelope bursts, and it may be important to isolate the payload from those loads.

### BRIEF SUMMARY

One aspect of the disclosure provides a system including a mechanical fuse. The mechanical fuse includes a first component having an opening in a lower wall and a ledge arranged around the opening, a second component having a top surface with a threaded opening arranged therein, and a bolt having a head, a neck, and a threaded portion. The top surface of the second component being oriented towards the first component such that the top surface is arranged entirely below the lower wall in order to enable the first component and the second component to pivot relative to one another at a bolt. The neck of the bolt includes a reduced cross-sectional area portion, the head is arranged in the first opening and the ledge prevents the bolt from passing through the first opening, the threaded portion is arranged in the threaded opening of the second component and thereby clamp the first component to the second component. The bolt is configured to break and separate the first component from the second component when a predetermined amount of force is transmitted from the first component to the reduced cross-sectional area portion via moments caused by the pivoting.

In one example, the first component includes a body with an interior space through which the bolt can be placed in order to clamp the first component to the second component. In this example, the body includes a pair of opposing lateral openings, wherein the pair of opposing lateral openings enable the first component to be attached to an object. In another example, the second component is arranged as a mounting plate that enables the second component to be attached to an object. In another example, the system also includes first and second projections extending from the lower wall of the first component, and first and second projections are arranged in respective openings in the top surface of the second component, and wherein the first and second projections are configured to limit rotation of the first component relative to the second component. In this example, the first and second projections are spherical pins. In addition, the respective openings are conical holes. In another example, the second component includes a sidewall having a second threaded opening therein, wherein an area of the threaded portion is exposed to the second threaded opening. In another example, the system also includes a set screw arranged in the second threaded opening in order to deform the area of the threaded portion to prevent the threaded portion from decoupling from the threaded opening. In another example, the system also includes an aerial vehicle having an envelope and a payload, wherein the mechanical fuse is arranged between the envelope and the payload. In this example, the bolt is also configured to separate the envelope from the payload when the predetermined amount of force is transmitted from the first component to the reduced cross-sectional area portion. In addition, the predetermined amount of force is greater than expected lateral forces on the first component during launch of the aerial vehicle. In addition or alternatively, the predetermined amount of force is greater than expected lateral forces on the first component during flight of the aerial vehicle. In addition or alternatively, the predetermined amount of force enables the bolt to break in response to forces caused by the envelope bursting during flight. In addition or alternatively, the first component and second component are arranged such that when the bolt breaks, the first component will remain attached to the envelope and the second component will remain attached to the payload. In addition or alternatively, the aerial vehicle includes a flexible portion arranged between the envelope and the payload to enable the envelope to pivot relative to the payload, and wherein the mechanical fuse is arranged between the flexible portion and the payload. In another example, the second component is arranged entirely below the lower wall.

### BRIEF DESCRIPTION OF THE DRAWINGS

FIG. 1 is an example system including a network of aerial vehicles in accordance with aspects of the disclosure.

FIG. 2 is an example of an aerial vehicle in accordance with aspects of the present disclosure.

FIG. 3 is an example of an aerial vehicle in flight in accordance with aspects of the disclosure.

FIG. 4 is a perspective view of a connection between an envelope and a payload of an aerial vehicle in accordance with aspects of the disclosure.

FIG. 5 is a cross-sectional view of a mechanical fuse including a portion of the flexible feature in accordance with aspects of the disclosure.

FIG. 6 is a break-away perspective view of a mechanical fuse in accordance with aspects of the disclosure.

FIG. 7 is a partial cross-sectional view of portions of a mechanical fuse in accordance with aspects of the disclosure.

FIG. 8A is an example view of a screw in accordance with aspects of the disclosure.

FIG. 8B is an example view of a screw in accordance with aspects of the disclosure.

### DETAILED DESCRIPTION

### Overview

The technology relates to a mechanical fuse that is capable of breaking at different load values in any direction that is perpendicular to a vertical connection between two objects, such as an envelope of an aerial vehicle (e.g. a balloon or airship) and a payload (which may include sensitive equipment) beneath the envelope. For example, an aerial vehicle may be subject to significant tensile forces during launch as well as vibration and turbulence when in flight. In addition to vibration and turbulence, the payload can experience extreme forces if or when the envelope bursts, and it may be important to isolate the payload from those loads.

To address these concerns, a connection between an envelope and a payload of the aerial vehicle may include a mechanical fuse which can enable automatic separation of the payload and the envelope. The fuse may attach to a flexible feature which connects via one or more additional features to a base plate of the envelope. The flexible feature may be a flexible connection configured to bend or flex like a knuckle in order to allow the payload to remain level while the balloon tilts without transmitting large moments as a rigid connection would. The fuse may also attach to the payload of the aerial vehicle via an adapter portion of a despin mechanism that may adjust for the relative rotations of the envelope and the payload by torqueing the payload against the envelope.

The fuse may include a bolt, a first component, and a second component. The bolt may include a head, a neck having a reduced cross-sectional area portion, and a threaded portion. The reduced cross-sectional area portion may be selected based upon the axial forces expected to be experienced by the bolt during launch and in flight other than during a burst situation.

The first component may be an upper component or rather, arranged above the second component and the payload when the aerial vehicle is in flight. The first component may include a body having a circular cross-section along a length of the body. The first component first and second openings at opposing ends of the first component. Between these openings may be an interior space. The body may include a pair of opposing lateral openings therethrough. These opposing lateral openings may enable the attachment of the fuse to the flexible feature.

A second opening may be arranged in a lower wall of one of the ends. The second opening includes a ledge formed by the lower wall. The third opening may be sized to receive the threaded portion of the bolt therethrough, and the ledge may be configured to prevent the head of the bolt from passing through the second opening when the bolt is seated in the first component. The reduced cross-sectional area portion of the neck may be arranged such that when the bolt is seated in the first component, the reduced cross-sectional area portion is positioned within the second opening or rather, within the lower wall. In this configuration, the body may act as a lever arm when transferring perpendicular forces from the first component to the bolt.

The second component may be a lower component or rather, arranged below the first component (and above the payload) when the aerial vehicle is in flight. The second component may include a top surface. The top surface may be oriented towards the first component when the first component and the second component are engaged with one another. The top surface also includes an opening therein for receiving a threaded portion of the bolt. In this regard, the top surface and/or the second component may be arranged entirely below the lower wall in order to enable the first component and the second component to pivot relative to one another at the bolt in order to transfer moment forces at the end to the bolt.

The second component may also include one or more side walls having one or more threaded openings therein. Set screws may be placed into the threaded openings in order to contact and deform the threads of the bolt. This may prevent the bolt from decoupling from the second opening. The second component may also include other features such as a plurality of openings that allow the second component to act as a mounting plate.

Because of the reduced cross-sectional area portion, the bolt may not be able to transmit much torque without failing. However, the configuration of the bolt may provide for the bolt to withstand a higher amount of torque before failing as compared to a similarly sized bolt. To allow for better torque transmission, the first component and the second component may also include anti-rotation features to allow for torque to be transmitted.

The features of the first component may be such that a small load applied perpendicularly to the end of the first component will result in a large moment being applied to the bolt. This large moment may lead to increasing tension in the bolt and eventual failure at the reduced cross-sectional area portion of the bolt. This may prevent any further load from being transmitted into the payload. The mechanical fuse described herein may be especially useful for separating two objects subject to forces in any direction perpendicular to a vertical connection between those two objects, such as an envelope of an aerial vehicle and a payload beneath the envelope. In this regard, the fuse may prevent excessive forces from such directions from being transmitted from the envelope and into the payload to prevent features from falling off the aerial vehicle and protect sensitive equipment. Otherwise all components on the payload would need to be designed to withstand burst loads. This would add a substantial amount of weight. This may be important as the envelope may burst in any of these directions. In addition, the fuse may survive large tensile forces including forces of launch as well as vibration and turbulence experienced when in flight while also being able to break easily when there is a burst.

### Example System

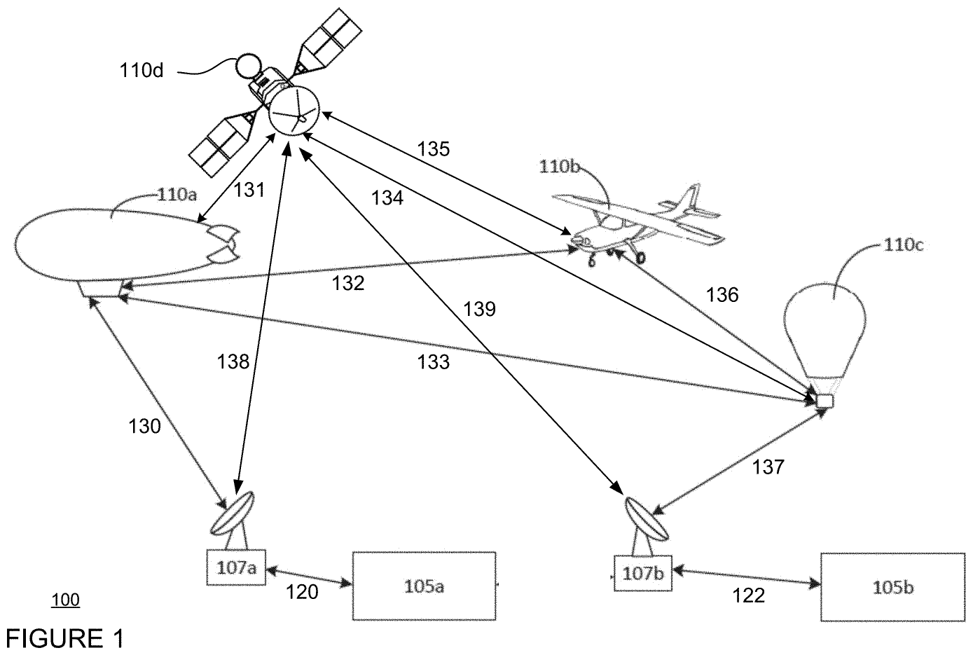

FIG. 1 is a block diagram of an example directional point-to-point network 100. The network 100 is a directional point-to-point computer network consisting of nodes mounted on various land- and air-based devices, some of which may change position with respect to other nodes in the network 100 over time. For example, the network 100 includes nodes associated with each of two land-based datacenters 105a and 105b (generally referred to as data centers 105), nodes associated with each of two ground stations 107a and 107b (generally referred to as ground stations 107), and nodes associated with each of four airborne high altitude platforms (HAPs) 110a, 110b, 110c, 110d (generally referred to as HAPs 110). As shown, HAP 110a is an aerial vehicle (here depicted as a blimp), HAP 110b is an airplane, HAP 110c is an aerial vehicle (here depicted as a balloon), and HAP 110d is a satellite. In some embodiments, nodes in network 100 may be equipped to perform FSOC, making network 100 an FSOC network. Additionally or alternatively, nodes in network 100 may be equipped to communicate via radio-frequency signals or other communication signals capable of travelling through free space. Arrows shown between a pair of nodes represent possible communication links 120, 122, 130-137 between the nodes. The network 100 as shown in FIG. 1 is illustrative only, and in some implementations the network 100 may include additional or different nodes. For example, in some implementations, the network 100 may include additional HAPs, which may be balloons, blimps, airplanes, unmanned aerial vehicles (UAVs), satellites, or any other form of high-altitude platform.

In some implementations, the network 100 may serve as an access network for client devices such as cellular phones, laptop computers, desktop computers, wearable devices, or tablet computers. The network 100 also may be connected to a larger network, such as the Internet, and may be configured to provide a client device with access to resources stored on or provided through the larger computer network. In some implementations, HAPs 110 can include wireless transceivers associated with a cellular or other mobile network, such as eNodeB base stations or other wireless access points, such as WiMAX or UMTS access points. Together, HAPs 110 may form all or part of a wireless access network. HAPs 110 may connect to the data centers 105, for example, via backbone network links or transit networks operated by third parties. The data centers 105 may include servers hosting applications that are accessed by remote users as well as systems that monitor or control the components of the network 100. HAPs 110 may provide wireless access for the users, and may route user requests to the data centers 105 and return responses to the users via the backbone network links.

### Example Aerial Vehicle

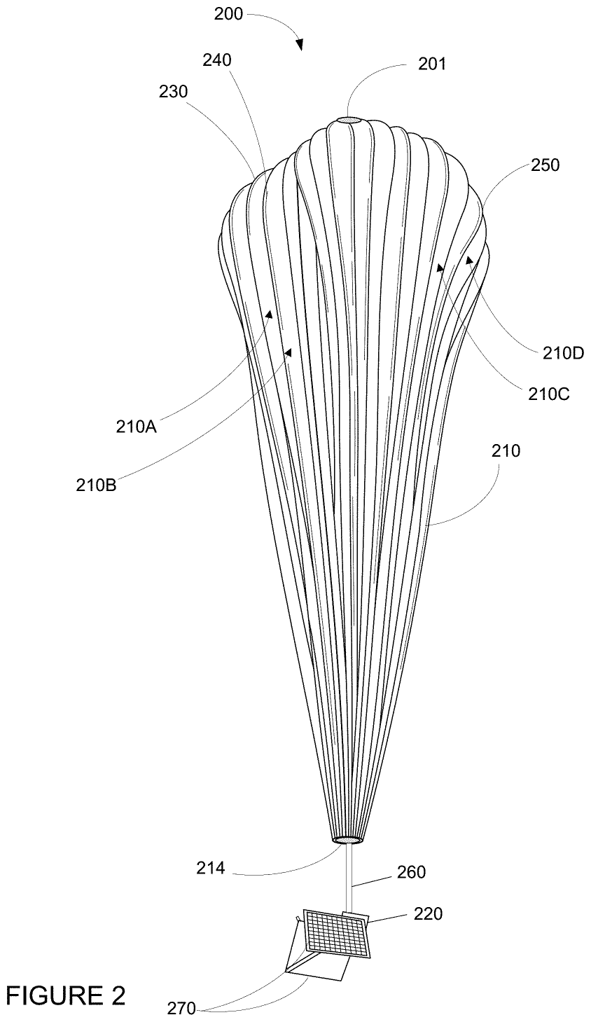

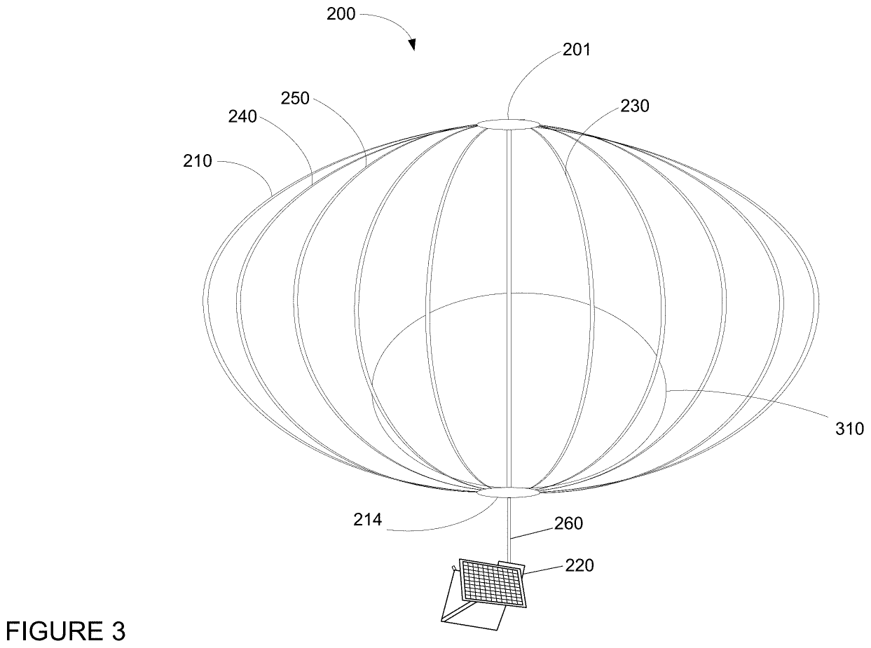

FIGS. 2 and 3 are examples of an aerial vehicle 200 which may correspond to HAP 110c, again, depicted here as a balloon. For ease of understanding, the relative sizes of and distances between aspects of the aerial vehicle 200 and ground surface, etc. are not to scale. As shown, the aerial vehicle 200 includes an envelope 210, a payload 220 and a plurality of tendons 230, 240 and 250 attached to the envelope 210. The envelope 210 may take various forms. In one instance, the envelope 210 may be constructed from materials (i.e. envelope material) such as polyethylene that do not hold much load while the aerial vehicle 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, or any other lighter-than-air gas. The envelope 210 is thus arranged to have an associated upward buoyancy force during deployment of the payload 220.

The payload 220 of aerial vehicle 200 may be affixed to the envelope by a connection 260 such as a cable and/or other rigid structures having various features as discussed further below. The payload 220 may include a computer system (not shown), having one or more processors and on-board data storage. The payload 220 may also include various other types of equipment and systems (not shown) to provide a number of different functions. For example, the payload 220 may include various communication systems such as optical and/or RF, a navigation software module, a positioning system, a lighting system, an altitude control system (configured to change an altitude of the aerial vehicle in order to follow navigation instructions), a plurality of solar panels 270 for generating power, and a power supply 280 (such as one or more of the batteries discussed further below) to store power generated by the solar panels. The power supply may also supply power to various components of aerial vehicle 200.

In view of the goal of making the envelope 210 as lightweight as possible, it may be comprised of a plurality of envelope lobes or gores that have a thin film, such as polyethylene or polyethylene terephthalate, which is lightweight, yet has suitable strength properties for use as an envelope. In this example, envelope 210 comprises envelope gores 210A, 210B, 210C, 210D.

Pressurized lift gas within the envelope 210 may cause a force or load to be applied to the aerial vehicle 200. In that regard, the tendons 230, 240, 250 provide strength to the aerial vehicle 200 to carry the load created by the pressurized gas within the envelope 210. In some examples, a cage of tendons (not shown) may be created using multiple tendons that are attached vertically and horizontally. Each tendon may be formed as a fiber load tape that is adhered to a respective envelope gore. Alternatively, a tubular sleeve may be adhered to the respective envelopes with the tendon positioned within the tubular sleeve.

Top ends of the tendons 230, 240 and 250 may be coupled together using an apparatus, such as top plate 201 positioned at the apex of envelope 210. A corresponding apparatus, e.g., a bottom or base plate 214, may be arranged at a base or bottom of the envelope 210. The top plate 201 at the apex may be the same size and shape as and base plate 214 at the bottom. Both caps include corresponding components for attaching the tendons 230, 240 and 250 to the envelope 210.

FIG. 3 is an example of the aerial vehicle 200 in flight when the lift gas within the envelope 210 is pressurized. In this example, the shapes and sizes of the envelope 210, connection 260, envelope 310, and payload 220 are exaggerated for clarity and ease of understanding. During flight, these balloons may use changes in altitude to achieve navigational direction changes. In this regard, the envelope 310 may be a ballonet that holds ballast gas (e.g., air) therein, and the envelope 210 may hold lift gas around the ballonet. For example, the altitude control system of the payload 220 may cause air to be pumped into a ballast within the envelope 210 which increases the mass of the aerial vehicle and causes the aerial vehicle to descend. Similarly, the altitude control system may cause air to be released from the ballast (and expelled from the aerial vehicle) in order to reduce the mass of the aerial vehicle and cause the aerial vehicle to ascend. Alternatively, in a reverse ballonet configuration, the envelope 310 may hold lift gas therein and the envelope 210 may hold ballast gas (e.g., air) around the envelope 310, and the envelope 310 may hold the lift gas therein. In either case, the envelope 310 may be attached to one or both of the top plate 201 or the base plate 214 (attachment to the base plate being depicted in FIG. 3).

### Example Mechanical Fuse

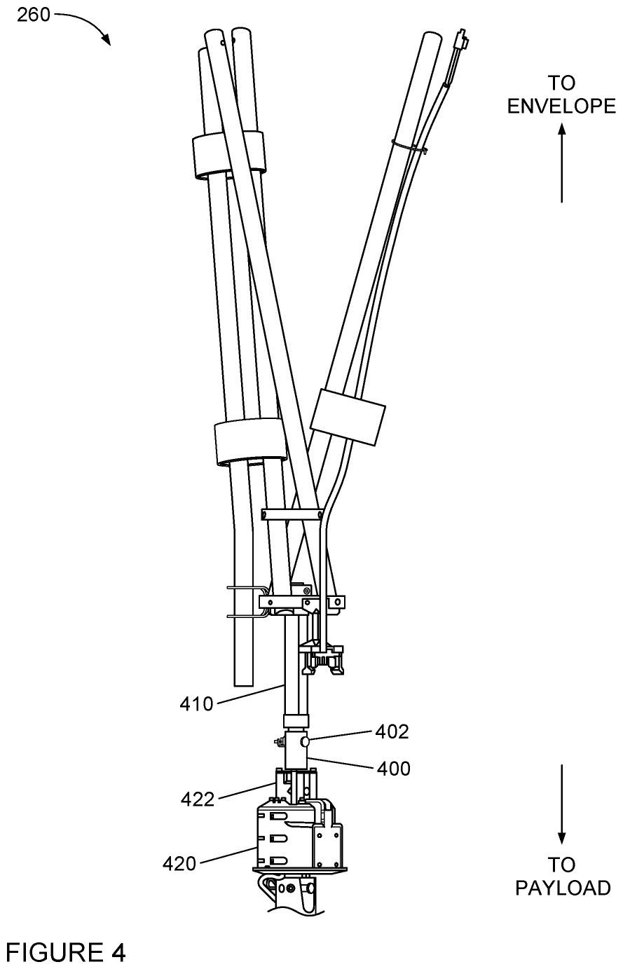

FIG. 4 depicts a perspective view of the connection 260. The connection 260 may include a mechanical fuse 400, a flexible feature 410, and a despin mechanism 420. The fuse may be arranged along the connection 260 such that when the aerial vehicle 200 is in flight, the fuse 400 is positioned between the envelope 210 and the payload 220. In this regard, the fuse 400 may attach to the flexible feature 410, which connects via one or more additional features to the base plate 214 of the envelope 210. The fuse 400 may also attach to the payload 220 of the aerial vehicle via an adapter portion 422 of the despin mechanism 420 that may adjust for the relative rotations of the envelope 210 and the payload 220 by torqueing the payload (e.g. rotating) against the envelope.

As an example, the flexible feature 410 may be a flexible connection configured to bend or flex like a knuckle in order to allow the payload to remain level and prevent large moments from being transmitted into the payload when the balloon tilts over. For instance, when there is a rigid connection between the envelope and the payload, the entire aerial vehicle may tend to tilt relative to the ground at various altitudes. Such tilting can be undesirable. For example, if there was no flexible feature, the moment (or perpendicular force) that would be passed through to the payload 220 would be massive and may cause a failure in some component of the aerial vehicle 200. The flexible feature may counteract this tilting by allowing the envelope and the payload to tilt relative to one another. The flexible feature may thus be used to keep the despin mechanism and payload level (to the ground) if the aerial vehicle begins to tilt.

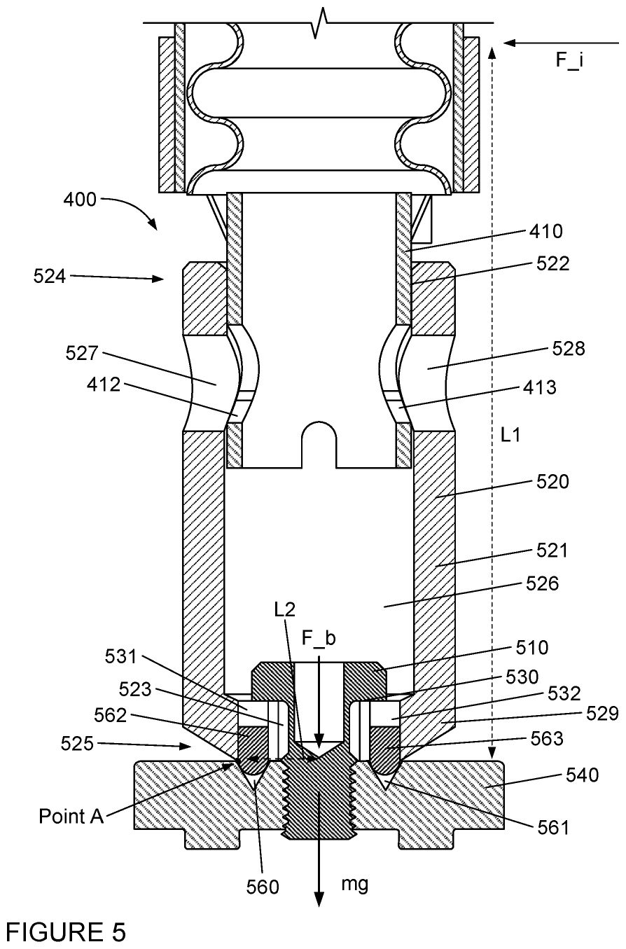

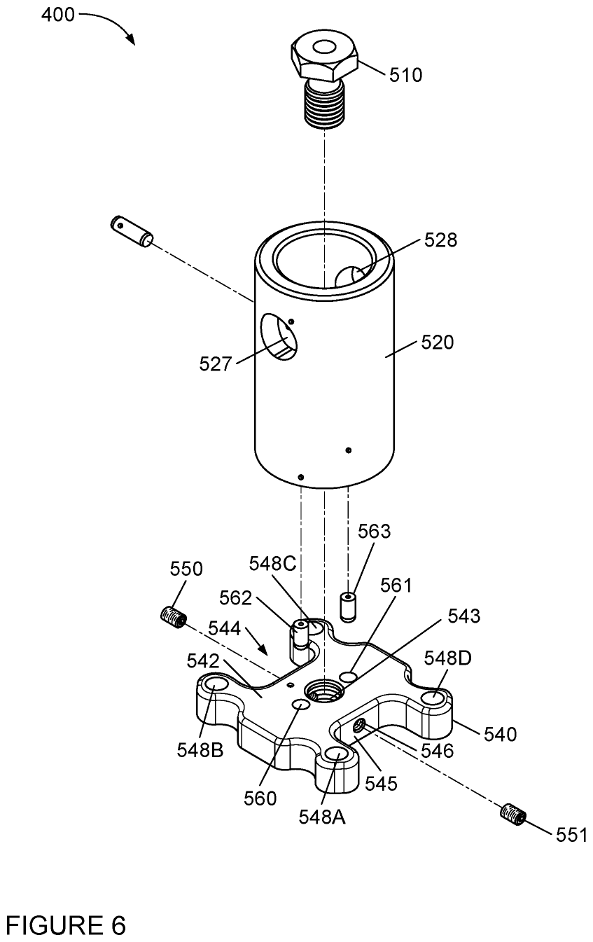

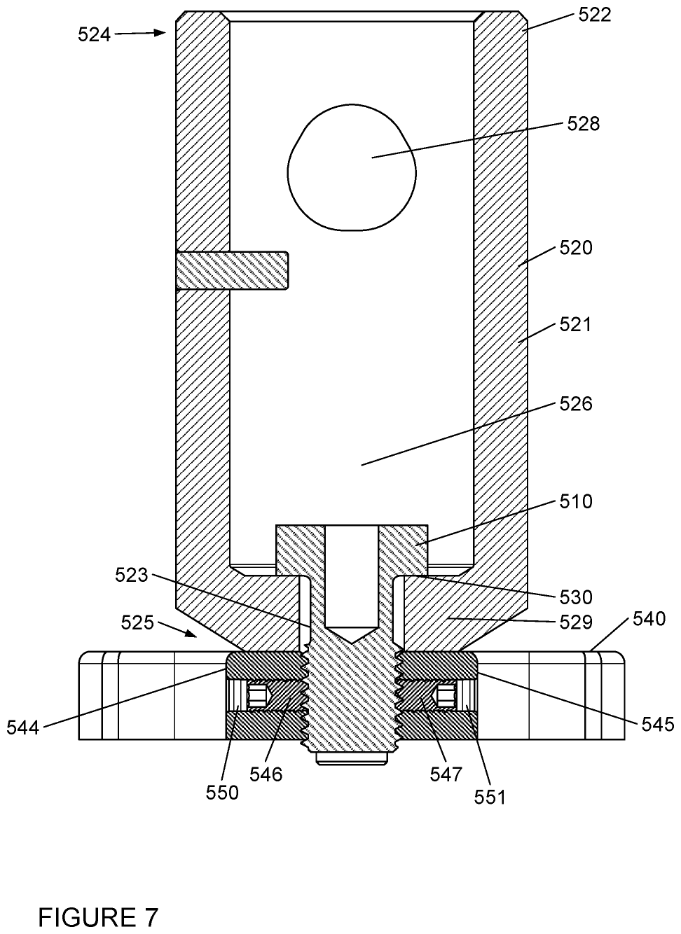

FIG. 5 provides a cross-sectional view of the fuse 400 including a portion of the flexible feature 410. FIG. 6 provides a break-away perspective view of the fuse 400. FIG. 7 provides a partial cross-sectional, detail view of the first component 520 and second component 540 at a different orientation (i.e. rotated 90 degrees) from the view of FIG. 5.

The fuse 400 may be configured to enable automatic separation of the payload and the envelope. In this regard, the fuse 400 may include a bolt 510, 810, a first component 520, and a second component 540. FIG. 5 depicts the fuse 400 with the first component and the second component engaged with one another. Each of the bolt, first component and second component may be formed from various materials including aluminum alloy such as those of grades 7075-T6, 6061-T6, 6070-T6, 6063-T832, 6063-T832, 6262-T9; titanium alloys such as Ti-6Al-4V and Ti-6Al-2Sn-4Zr-2Mo; and stainless steel such as 17-4 PH H1025.

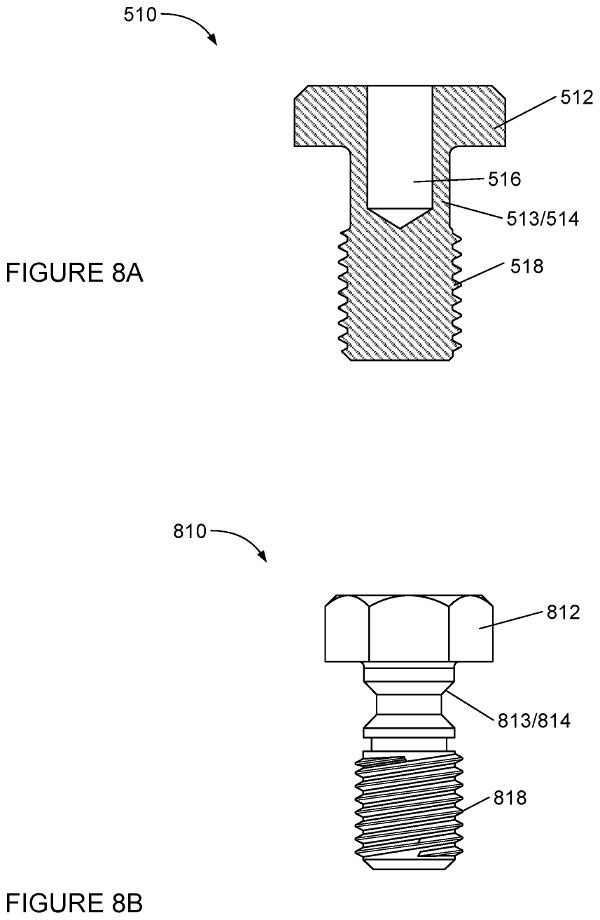

FIG. 8A provides a cross-sectional detail view of the bolt 510. Bolt 510 includes a head 512 and a neck 514 having a reduced cross-sectional area portion 513 or reduced diameter portion that clamps first and second components together. In this example, the bolt includes a reduced cross-sectional area portion due to an opening 516 that extends into the bolt 510 from the head 512 towards a threaded portion 518. FIG. 8B depicts a perspective view of an alternative configuration of a bolt 810 which may be used in place of bolt 510 in fuse 400. In this example, the bolt 810 includes a head 812, a neck 814 having a reduced cross-sectional area portion 813, and a threaded portion 818. In this example, the reduced cross-sectional area portion 813 corresponds to a reduced diameter portion of the neck 514 rather than an opening that extends into the bolt. In addition, bolt 810 may be less susceptible to manufacturing defects (e.g. problems caused by the accuracy of the machining process). For example, if the opening 516 of bolt 510 is shifted too much to one side of the head 512, this could lead to premature failure of the bolt 510. However, at the same time, bolt 510 may be able to support larger moments before failure than bolt 810.

The total cross-sectional area portion of the reduced cross-sectional area portion may be selected based upon the axial forces expected to be experienced by the bolt during launch and in flight other than during a burst situation. In this regard, when a predetermined amount of force is transmitted from the first component to the reduced cross-sectional area portion via the first component pivoting relative to the second component, the bolt will break, separating the first component from the second component. Because of the configuration of the connection 260, the first component will remain attached to the envelope, and the second component will remain attached to the payload. To prevent premature separation of the first and second components, the predetermined amount of force should be greater than expected lateral forces on the first component during launch and flight of the aerial vehicle. For instance, if a 120 kg payload is expected to experience 4.25 g during launch, the bolt may need to handle as much as 5.2 kN, or more or less.

As shown in FIGS. 5, 6, and 7, the first component 520 may be an upper component or rather, arranged above the second component 540 and the payload 220 when the aerial vehicle is in flight. The first component 520 may include a body 521 having a circular cross-section along a length L1 of the body. The first component 520 may include first and second openings 522, 523 at opposing ends 524, 525 of the first component. Between these openings is an interior space 526. The body 521 includes a pair of opposing lateral openings 527, 528 therethrough. These opposing lateral openings 527, 528 may enable the attachment of the fuse to the flexible feature 410. For instance, as shown, a portion of the flexible feature 410 may be positioned within the interior space 526. A bolt 402 (shown in FIG. 4) may be placed through the pair of openings and a corresponding pair of openings 412, 413 through the flexible feature 410 in order to secure the first component 520 to the flexible feature 410.

The second opening 523 is arranged in a lower wall 529 of one of the ends 525. The diameter of the body at the end 525 at the lower wall 529 is narrower than the diameter of the body at the end 524 which is adjacent to the second component 540. The second opening includes a ledge 530 formed by the lower wall 529. The third opening may be sized to receive the threaded portion 518, 818 of the bolt 510, 810 therethrough, and the ledge 530 may be configured to prevent the head 512, 812 of the bolt 510, 810 from passing through the second opening 523 when the bolt 510, 810 is seated in the first component 520. The reduced cross-sectional area portion 513, 813 of the neck may be arranged such that when the bolt 510, 810 is seated in the first component 520, the reduced cross-sectional area portion is positioned within the second opening 523 or rather, within the lower wall 529.

The second component 540 may be a lower component or rather, arranged below the first component 520 (and above the payload 220) when the aerial vehicle is in flight. The second component may include a top surface 542. The top surface 542 may be oriented towards the first component when the first component and the second component are engaged with one another. The top surface 542 also includes an opening 543 therein for receiving the threaded portion 518, 818 of the bolt 510, 810. In this regard, the top surface 542 and/or the second component is arranged entirely below the lower wall 529 in order to enable the first component and the second component to pivot relative to one another at the bolt 510, 810 in order to transfer moment forces at the end 524 to the bolt.

As depicted in FIG. 7, the reduced-cross sectional portion of the bolt may not actually not line up between the upper component and the lower component. Sharp corners, such as those of the threads of the threaded portions 518, 818 may cause stress concentrations which may become a problem under fatigue. Because the bolt is supported at the head, the portion of the bolt between the bottom of the head and the top of the threaded portion see the same load, but not the same stress (which is determined based on the cross-sectional area).

Turning to FIGS. 6 and 7, the second component 540 may also include one or more sidewalls 544, 545 having one or more threaded openings 546, 547 therein. When the first component is engaged with the second component, the threaded portion of the bolt 510, 810 is exposed to each of the threaded openings 547, 547. Set screws 550, 551 may be placed into the threaded openings 546, 547 in order to contact and deform the threads of the bolt 510, 810. This may prevent the bolt 510, 810 from decoupling from the second opening 523.

The second component 540 may also include other features such as a plurality of openings 548A, 548B, 548C, 548D that allow the second component to act as a mounting plate. For instance, the openings 548A, 548B, 548C, 548D may be threaded openings or alternatively clearance holes which can be used to secure the second component to the adapter portion 422 of the despin mechanism 420, another feature above the payload 220, or the payload itself via bolts, screws, or other fasteners.

Because of the reduced cross-sectional area portion, the bolt may not be able to transmit much torque without failing. However, the configuration of the bolt 510 may provide for the bolt 510 to withstand a higher amount of torque before failing as compared to a similarly sized bolt having the configuration of bolt 810. To allow for better torque transmission, the first component 520 and the second component 540 may also include anti-rotation features to allow for torque to be transmitted.

For instance, the first component may include two openings 531, 532 in the lower wall 529 that may be aligned with a corresponding pair of depressions, shallow openings, or conical holes 560, 561 in the top surface 542. The fuse 400 may also include a pair of projections or pins 562, 563. The pins may be spherical pins, that is, pins having ends with semi-spherical shapes which can engage with the conical holes 560, 561. The pins 562, 563 may be placed into respective ones of the two openings 531, 532 such that tips of the pair of pins extend below the lower wall 529 and are arranged within the conical holes 560, 561 when the first component 520 and second component 540 are engaged with one another. This may effectively increase the length of the moment arm formed by the length L1 of the body 521 and allow for much larger torques to be transmitted through the fuse 400 while still allowing for the separation of the first and second components without changing the moments applied.

The features of the first component 520 may be such that a small load applied perpendicularly to the end of the first component will result in a large moment being applied to the bolt 510, 810. This large moment may lead to increasing tension in the bolt and eventual failure at the reduced cross-sectional area portion 513, 813 of the bolt 510, 810. This may prevent any further load from being transmitted into the payload 220. The fuse may be sized to a given range of payload masses. In addition, because a moment is a mechanical advantage and increases tension, this may allow for a larger range of payload masses than strictly a tension-based fuse.

The body 521 may act as a lever arm when transferring perpendicular forces from the first component to the bolt. In this regard, a ratio of the length L1 of the body to the radius L2 of the body at the lower wall 529 may define how much of a lateral or perpendicular force Fi at the end 524 is applied to the bolt 510, 810 or, rather, the force Fb. To demonstrate the types of loads at which the fuse 400 may fail, a simplified example which assumes that the aerial vehicle is at rest and all of the moments should sum to zero, is provided. The body 521 may act as a lever arm when transferring perpendicular forces from the first component to the bolt. In this regard, a ratio of the length L1 of the body to the radius L2 of the body at the lower wall 529 may define how much of a lateral or perpendicular force Fi at the end 524 is applied to the bolt 510, 810 or, rather, the force Fb. In other words, the sum of all moments, Fb*L2−Fi*L2, would be zero. As such, the moment Fi*L1 equals the moment Fb*L2 and thus, Fb=Fi*L1/L2. Thus, increasing the length of L1 and decreasing the length of L2 increases the force Fb which would result in the bolt, and therefore the fuse, failing sooner because of increased tension.

Different calculations may be used for the yield (bending) tensile strength and the ultimate (breaking) tensile strength. For example, if L1 is 75.6 millimeters and L2 is 8.4 millimeters, then the ratio of L1/L2 is approximately 9.0. If the mass of the payload 220 is 120 kg, then the weight of the payload may be approximately 1177 Newtons. Using the ultimate tensile strength of the bolt, if the yield tensile strength of the bolt is 352 and the reduced cross-sectional area of the bolts is 23.29 square milliliters, then the value of Fb (or rather the force at which the bolt will begin to yield) may be 8197 Newtons. In order to determine the value Fi for the fuse to break, the weight of the payload may be subtracted from the yield force: 8197 Newtons—1177 Newtons=7020 Newtons. This value may then be multiplied by the ratio of L2/L1 (or divided by the ratio of L1/L2) to determine Fi or 783 Newtons. In this regard, in the example described, a force of 783 Newtons in the direction of the arrow Fi of FIG. 5 will cause the bolt to yield.

Using the ultimate tensile strength of the bolt, if the ultimate tensile strength of the bolt is 365 and the reduced cross-sectional area of the bolts is 23.29 square milliliters, then the value of Fb is the ultimate tensile rating of the bolt (or rather the force at which the bolt will break) may be 8500 Newtons. In order to determine the value Fi, the weight of the payload is subtracted from the yield force: 8197 Newtons−1177 Newtons=7020 Newtons. This value may then be multiplied by the ratio of L2/L1 (or divided by the ratio of L1/L2) to determine Fi or 817 Newtons. In this regard, in the example described, a force of 817 Newtons in the direction of the arrow Fi of FIG. 5 will cause the bolt to break.

The mechanical fuse described herein may be especially useful for separating two objects subject to forces in any direction perpendicular to a vertical connection between those two objects, such as an envelope of an aerial vehicle and a payload beneath the envelope. In this regard, the fuse may prevent excessive forces from such directions from being transmitted from the envelope and into the payload to prevent features from falling off the aerial vehicle and protect sensitive equipment. Otherwise all components on the payload would need to be designed to withstand burst loads. This would add a substantial amount of weight. This may be important as the envelope may burst in any of these directions. In addition, the fuse may survive large tensile forces including forces of launch as well as vibration and turbulence experienced when in flight while also being able to break easily when there is a burst.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
a mechanical fuse having:
a first component having a first opening in a lower wall and a ledge arranged around the first opening;
a second component having a top surface with a threaded opening arranged therein, the top surface of the second component being oriented towards the first component such that the top surface is arranged entirely below the lower wall in order to enable the first component and the second component to pivot relative to one another at a bolt; and
the bolt having a head, a neck, and a threaded portion, wherein the neck including a reduced cross-sectional area portion, the head is arranged in the first opening and the ledge prevents the bolt from passing through the first opening, the threaded portion is arranged in the threaded opening of the second component and thereby clamp the first component to the second component, and the bolt is configured to break and separate the first component from the second component when a predetermined amount of force is transmitted from the first component to the reduced cross-sectional area portion via moments caused by the pivoting.

2. The system of claim 1, wherein the first component includes a body with an interior space through which the bolt can be placed in order to clamp the first component to the second component.

3. The system of claim 2, wherein the body includes a pair of opposing lateral openings, wherein the pair of opposing lateral openings enable the first component to be attached to an object.

4. The system of claim 1, wherein the second component is arranged as a mounting plate that enables the second component to be attached to an object.

5. The system of claim 1, further comprising first and second projections extending from the lower wall of the first component, and first and second projections are arranged in respective openings in the top surface of the second component, and wherein the first and second projections are configured to limit rotation of the first component relative to the second component.

6. The system of claim 5, wherein the first and second projections are spherical pins.

7. The system of claim 6, wherein the respective openings are conical holes.

8. The system of claim 1, wherein the second component includes a sidewall having a second threaded opening therein, wherein an area of the threaded portion is exposed to the second threaded opening.

9. The system of claim 8, further comprising a set screw arranged in the second threaded opening in order to deform the area of the threaded portion to prevent the threaded portion from decoupling from the threaded opening.

10. The system of claim 1, further comprising an aerial vehicle having an envelope and a payload, wherein the mechanical fuse is arranged between the envelope and the payload.

11. The system of claim 10, wherein the bolt is further configured to separate the envelope from the payload when the predetermined amount of force is transmitted from the first component to the reduced cross-sectional area portion.

12. The system of claim 11, wherein the predetermined amount of force is greater than expected lateral forces on the first component during launch of the aerial vehicle.

13. The system of claim 11, wherein the predetermined amount of force is greater than expected lateral forces on the first component during flight of the aerial vehicle.

14. The system of claim 11, wherein the predetermined amount of force enables the bolt to break in response to forces caused by the envelope bursting during flight.

15. The system of claim 10, wherein the first component and second component are arranged such that when the bolt breaks, the first component will remain attached to the envelope and the second component will remain attached to the payload.

16. The system of claim 10, wherein the aerial vehicle includes a flexible portion arranged between the envelope and the payload to enable the envelope to pivot relative to the payload, and wherein the mechanical fuse is arranged between the flexible portion and the payload.

17. The system of claim 1, wherein the second component is arranged entirely below the lower wall.
